(19) United States
(12) Patent Application Publication
(10) Pub. No.: US 2013/0099494 A1
(43) Pub. Date: Apr. 25, 2013

(54) WIND TURBINE GENERATOR AND YAW CONTROL METHOD FOR WIND TURBINE GENERATOR

(71) Applicants: Tomohiro NUMAJIRI, Tokyo (JP); Yoshiyuki HAYASHI, Tokyo (JP)

(72) Inventors: Tomohiro NUMAJIRI, Tokyo (JP); Yoshiyuki HAYASHI, Tokyo (JP)

(73) Assignee: MITSUBISHI HEAVY INDUSTRIES, LTD., Tokyo (JP)

(21) Appl. No.: 13/361,682

(22) Filed: Jan. 30, 2012

Related U.S. Application Data
(63) Continuation of application No. PCT/JP2011/074321, filed on Oct. 21, 2011.

(51) Int. Cl. H02P 9/04

(52) U.S. Cl. 290/44

(57) ABSTRACT

A wind turbine generator, which is a wind turbine generator that turns a nacelle in the yaw direction by using the force that acts on turbine blades, includes a yaw brake device that stops the turning of the nacelle in the yaw direction and a control device that controls the yaw brake device so that the turning speed of the nacelle falls within a predetermined range. Therefore, the wind turbine generator can make the turning speed of the nacelle constant.

### CROSS REFERENCE TO RELATED APPLICATIONS

This is a continuation of International Application PCT/JP2011/074321, with an international filing date of Oct. 21, 2011, which is hereby incorporated by reference herein in its entirety.

### TECHNICAL FIELD

The present invention relates to a wind turbine generator and a yaw control method for a wind turbine generator.

### BACKGROUND ART

In a wind turbine generator, a rotor head provided with turbine blades rotates by receiving wind force, and electric power is generated by driving a generator by increasing the speed of this rotation with a gearbox. In addition, because the rotor head provided with the turbine blades is connected with the gearbox and the generator in a nacelle mounted at the top of a tower (pillar) via a main shaft, in order to align the orientation of the rotor head with the constantly changing wind direction (in order to make the plane of rotor rotation directly face the wind direction), for example, in an upwind-type wind turbine generator, it is necessary to receive the wind from the front side of the rotor head by yawing (turning on a substantially horizontal plane) the nacelle.

Conventional wind turbine generators include a wind turbine generator in which a yaw drive device for turning the nacelle in a yaw direction is installed. For example, as shown in FIG. 6, a yaw drive device causes yawing of a nacelle 102 with a driving force of a yaw motor 100 so that the rotation plane of a rotor head follows the wind direction in such a manner as to directly face it. Note that, in the figure, reference sign 102a is a nacelle base plate, 104 is a tower, 106 is a drive gear, 108 is a stationary gear, 110 is a roller bearing, and 112 is a yaw brake device; however, a sliding bearing may be employed instead of the roller bearing 110.

In addition, with regard to the above-described yaw drive device, with an increase in size of the wind turbine generator, the yaw motor, drive-system gears, etc. also increase in size. Because such an increase in the size of the yaw drive device increases the complexity of the nacelle base plate and the requirements with regard to maintenance space, it hinders size reduction and weight reduction.

Therefore, PTL 1 discloses a wind turbine generator in which an angle command value is calculated by adding a yaw control command value to a reference command value for offsetting a load around a tower axis that acts on each turbine blade, and a pitch-angle command value for each turbine blade is set on the basis of this angle command value. Specifically, the wind turbine generator disclosed in PTL 1 controls the pitch angle of each turbine blade by measuring a load on each turbine blade, and the nacelle is turned by using the aerodynamic force that acts on the turbine blades, therefore, the nacelle can be turned without employing a yaw drive device.

### CITATION LIST

### Patent Literature

{PTL 1} Japanese Unexamined Patent Application, Publication No. 2008-286156.

### SUMMARY OF INVENTION

### Technical Problem

With a wind turbine generator that turns a nacelle in the yaw direction with a yaw drive device, the nacelle can be directed at an arbitrary yaw angle regardless of the wind direction and wind speed.

On the other hand, in a wind turbine generator which is not provided with a yaw device and in which the nacelle is turned in the yaw direction by using force that acts on the turbine blades by controlling the pitch angle of each turbine blade, as in PTL 1, the turning nacelle is directed to an arbitrary yaw angle with the braking force of a yaw brake device which can be switched between operating (on) and non-operating (off) status.

However, with the wind turbine generator that turns the nacelle in the yaw direction with the force that acts on the turbine blades, because the wind force received by the turbine blades is large, when force acting in the yaw direction transmitted to the nacelle increases, the brake may slip even if the brake device is activated, and the nacelle may be oriented in an unintended direction.

In addition, the actual yaw moment (moment about the tower axis) is not constant but fluctuates, and fluctuations like those shown in FIG. 7 are repeated, for example, at a cycle from 1N (one fluctuation per rotation) to 3N (three (in case of a wind turbine generator with three blades) fluctuations per rotation). In addition, the average yaw moment M_{yaw-a} tends to be smaller (M_{yaw-a}<<ΔM_{yaw}) than the fluctuation amplitude ΔM_{yaw}. This indicates that a large moment that turns the nacelle left and right repeatedly occurs with a short period. However, in the wind turbine generator in which the nacelle is turned in the yaw direction by using the force that acts on the turbine blades, it is difficult to keep the turning speed (angular speed) of the nacelle constant by changing the pitch angle of each turbine blade in a short period in accordance with the yaw-moment fluctuations.

The present invention has been conceived in light of the above-described circumstances, and an object thereof is to provide a wind turbine generator that is capable of making the nacelle turning speed constant even with a configuration in which the nacelle is turned in the yaw direction by using the force that acts on the turbine blades, and to provide a yaw control method for a wind turbine generator.

### Solution to Problem

A wind turbine generator according to an aspect of the present invention is a wind turbine generator that turns a nacelle in a yaw direction by using force that acts on wind turbine blades, the wind turbine generator including a braking unit for stopping the turning of the nacelle in the yaw direction; and a controlling unit for controlling the braking unit so that turning speed of the nacelle falls within a predetermined range.

With the above-described configuration, the wind turbine generator turns the nacelle in the yaw direction by using the force that acts on the turbine blades and brakes the turning of the nacelle in the yaw direction with the braking unit.

In addition, with the controlling unit, the braking unit is controlled so that the turning speed of the nacelle falls within the predetermined range. In the case in which the turning speed of the nacelle falls outside of the predetermined range, the controlling unit causes the braking unit to generate a greater braking force to reduce the turning speed of the nacelle, thereby causing the turning speed to fall within the predetermined range. Accordingly, because the turning speed of the nacelle varies within the predetermined range even if the force acting in the yaw direction transmitted to the nacelle increases, the nacelle can be prevented from abruptly changing its orientation. Note that having the turning speed within the predetermined range means that the average turning speed falls within an allowable range, that the turning speed falls between a predetermined minimum value and maximum value, etc.

Therefore, with this configuration, because the braking unit is controlled so that the turning speed of the nacelle falls within the predetermined range, the turning speed of the nacelle can be made constant, even with the wind turbine generator that turns the nacelle in the yaw direction by using the force that acts on the turbine blades.

In the above-described first aspect, the braking unit preferably includes a plate-like brake disk and a plurality of brake pads that are pressed into contact with the brake disk, and in which at least one of a pressure that the brake pads apply to the brake disk and the number of brake pads to be pressed into contact with the brake disk is controlled so that the turning speed falls within the predetermined range.

With the above-described configuration, at least one of the pressure that the brake pads apply to the brake disk and the number of brake pads to be pressed into contact with the brake disk is controlled in the braking unit so that the turning speed falls within the predetermined range. In other words, because the braking force is controlled in accordance with the turning speed instead of performing simple on/off control of the braking unit, this configuration enables highly precise control of the turning speed.

In the above-described first aspect, it is preferable that a measuring unit for measuring the turning speed of the nacelle in the yaw direction be provided, wherein the controlling unit generates a control command value for the braking unit on the basis of a difference between the turning speed measured by the measuring unit and turning speed set in advance in the predetermined range so that the turning speed does not fall outside of the predetermined range.

With the above-described configuration, the control command value for the braking unit is generated on the basis of the difference between the turning speed measured by the measuring unit and the predetermined turning speed in the predetermined range so that the turning speed of the nacelle does not fall outside of the above-described predetermined range. For example, in the case in which the turning speed of the nacelle measured by the measuring unit is faster than the predetermined range, the control command value takes a value that causes the braking unit to generate a large braking force in order to reduce the turning speed.

Therefore, with this configuration, the nacelle turning speed can be made constant more reliably.

In the above-described first aspect, it is preferable that the predetermined range for the turning speed be from 0.25 degrees/second to 0.30 degrees/second.

With the above-described configuration, by setting the turning speed of the nacelle from 0.25 degrees/second to 0.30 degrees/second, abrupt turning of the nacelle in the yaw direction can be prevented while maintaining the tracking performance with respect to the wind direction, without causing mechanical strain.

A yaw control method for a wind turbine generator according to a second aspect of the present invention is a yaw control method for a wind turbine generator that turns a nacelle in a yaw direction by using force that acts on turbine blades and that is provided with a braking unit that brakes the turning of the nacelle in the yaw direction, including controlling the braking unit so that turning speed of the nacelle falls within a predetermined range.

### Advantageous Effects of Invention

With the present invention, an excellent advantage is afforded in that the turning speed of a nacelle can be made constant even with a configuration in which the nacelle is turned in the yaw direction by using the force that acts on turbine blades.

### BRIEF DESCRIPTION OF DRAWINGS

FIG. 1 is an external view of a wind turbine generator according to an embodiment of the present invention.

FIG. 2 is a diagram of the configuration for braking yawing of a nacelle according to the embodiment of the present invention.

FIG. 3 is a schematic diagram, showing the flow of forces that act on the nacelle.

FIG. 4 is a graph, showing an average, an allowable range, a minimum value, and a maximum value of the turning speed of the nacelle according to the embodiment of the present invention.

FIG. 5 is a functional block diagram, showing the functions of a control device according the embodiment of the present invention that are related to control of a yaw brake device.

FIG. 6 is a configuration diagram of a wind turbine generator that turns a nacelle by employing a yaw drive device.

FIG. 7 is a graph showing temporal changes in yaw moment.

### DESCRIPTION OF EMBODIMENT

An embodiment of the present invention will be described below.

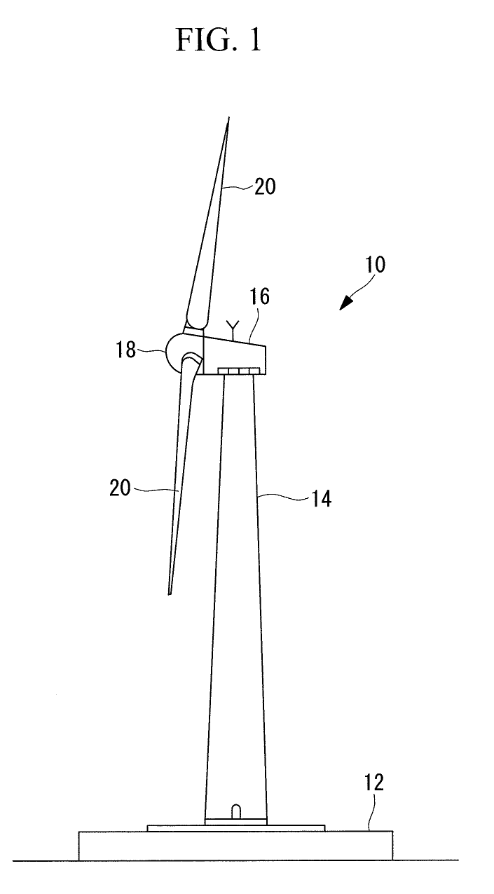

FIG. 1 is an external view of a wind turbine generator 10 according to this embodiment.

The wind turbine generator 10 shown in FIG. 1 includes a tower (pillar) 14 erected on a foundation 12, a nacelle 16 mounted at the top end of the tower 14, and a rotor head 18 provided on the nacelle 16 in a manner allowing rotation about a substantially horizontal axis.

A plurality (three, in this embodiment as an example) of turbine blades 20 are attached to the rotor head 18 in a radiating pattern about its rotation axis. Accordingly, the force of wind striking the turbine blades 20 from the rotation-axis direction of the rotor head 18 is converted to motive force that rotates the rotor head 18 about the rotation axis, and the motive force is converted to electric power by a generator. Note that the turbine blades 20 are connected to the rotor head 18 in a manner allowing movement with respect to the wind direction, thus making it possible to change pitch angles of the turbine blades 20.

The wind turbine generator 10 according to this embodiment controls the pitch angle of each turbine blade 20 by measuring a load on each turbine blade 20 and turns the nacelle 16 in the yaw direction (hereinafter, referred to as “yawing”) by using the force that acts on the turbine blades 20. In other words, a yaw drive device for yawing the nacelle 16 is not provided.

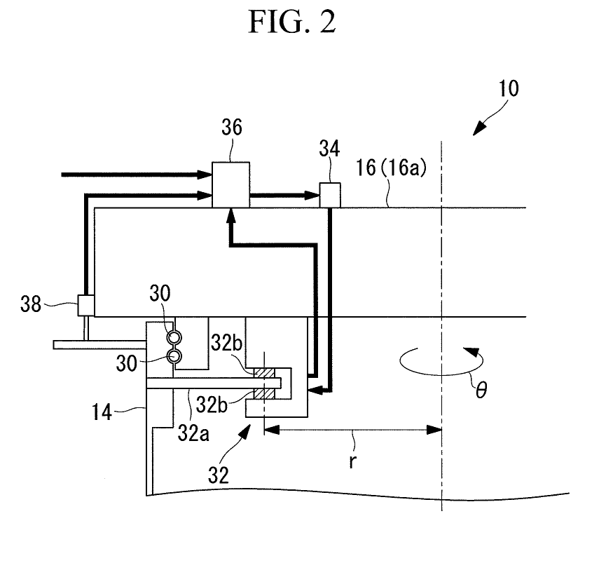

FIG. 2 is a diagram of the configuration for braking the yawing of the nacelle 16 according to this embodiment.

The nacelle 16 is supported on the tower 14 via a roller bearing 30 in a manner allowing turning thereof. In addition, the wind turbine generator 10 is provided with a yaw brake device 32 that brakes the yawing of the nacelle 16.

The yaw brake device 32 is provided with a plate-like brake disk 32a and a plurality of brake pads 32b that are pressed into contact with the brake disk 32a. For example, the brake disk 32a is provided at an inner circumference of the tower 14, and the plurality of the brake pads 32b are provided below the nacelle base plate 16a at equal intervals and equidistant from a yaw axis for the yawing of the nacelle 16. Then, the brake pads 32b are hydraulically driven and are pressed into contact with the brake disk 32a by sandwiching the brake disk 32a from above and below. By pressing the brake pads 32b into contact with the brake disk 32a, a braking torque is applied to the nacelle 16 during yawing, and the yawing of the nacelle 16 is slowed down.

The yaw brake device 32 is controlled by a yaw-brake control device 34 provided at a top surface of the nacelle base plate 16a.

The yaw-brake control device 34 controls the pressure that the brake pads 32b apply to the brake disk 32a and the number of brake pads 32b to be pressed into contact with the brake disk 32a on the basis of braking command values output from a control device 36 (for example, a PLC (programmable logic controller)) provided at the top surface of the nacelle base plate 16a, and thus, the braking force of the yaw brake device 32 is changed.

Various information is input to the control device 36, such as operation data of the wind turbine generator 10, pressure data indicating the pressure that the brake pads 32b apply to the brake disk 32a, rotational angle data output from a turning speed sensor 38 that measures the yaw-direction turning speed (angular speed) of the nacelle 16, etc., and the control device 36 generates the braking command values by using the input information. Note that, instead of the turning speed sensor 38 that measures the angular speed, an angular acceleration sensor that measures angular acceleration may be provided, and the angular speed may be detected on the basis of the measured angular acceleration.

Next, the relationship among a braking torque M_{YB} generated by the yaw brake device 32, force acting in the yaw direction (hereinafter, referred to as “nacelle rotational force M_{Ztt}”) that acts on the turbine blades 20 to be transmitted to the nacelle 16, and turning speed θ′ at which the nacelle 16 yaws will be described. Note that θ′ indicates the first derivative (speed) of yaw angle θ, and θ″ indicates the second derivative (acceleration) of the yaw angle θ.

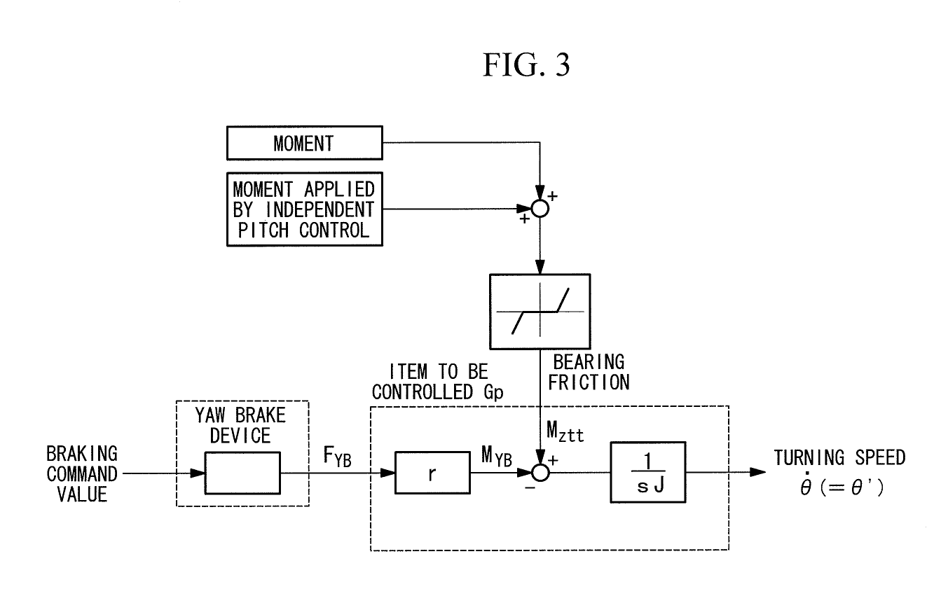

FIG. 3 is a schematic diagram, showing the flow of forces that act on the nacelle 16.

The yaw brake device 32 generates braking force F_{YB} that is generated by causing the brake pads 32b to be pressed into contact with the brake disk 32a on the basis of the braking command values. Accordingly, as shown in the following expression (1), the braking toque M_{YB} in accordance with the braking force F_{YB} and a distance r (see FIG. 2) from the brake pads 32b to a yawing center axis acts on the nacelle 16.

M_{YB}=F_{YB}×r (1)

Furthermore, the resultant force of the moment that acts on the turbine blades and the moment that acts due to independent pitch control acts on the nacelle 16. Note that the independent pitch control is control in which a blade-root load and a fluctuation in the blade-root load are reduced by a pitching operation of the turbine blades 20 in consideration of the wind speed distribution and wind direction over the entire rotor surface with respect to the wind turbine generator 10.

The difference between the above-described resultant force and the friction force (bearing friction) at the roller bearing 30, etc. provided at the nacelle 16 is the nacelle rotational force M_{Ztt}.

In addition, the difference between the nacelle rotational force M_{Ztt} and the braking torque M_{YB} causes the nacelle 16 to turn. Inertia (inertial force) acts on the nacelle 16 in accordance with the difference between the rotational force and the braking force, and thus, the nacelle 16 turns at turning speed θ′ in accordance with the inertia. By the action of these forces (turning force, moments, and rotational force), turning speed θ′ in accordance with the equations of motion is generated at the nacelle 16.

Here, in the case in which the nacelle rotational force M_{Ztt}>the braking torque M_{YB}, the yaw angle θ of the nacelle 16 changes such that θ′>0, thus increasing the turning speed θ′ of the nacelle 16, which in turn causes the turning angular acceleration θ″ of the nacelle 16 to be θ″>0. On the other hand, in the case in which the nacelle rotational force M_{Ztt}<the braking torque M_{YB}, the yaw angle θ of the nacelle 16 is constant, thus causing the turning speed θ′ and the turning angular acceleration θ″ of the nacelle 16 to be θ′=θ″=0. In this way, unless the braking torque M_{YB} generated by the yaw brake device 32 is appropriately controlled, the nacelle 16 continues to rotate in the yaw direction while accelerating or comes to a halt. In other words, in the case in which the nacelle rotational force M_{Ztt} is acting on the nacelle 16, it is preferable that the yawing speed θ′ of the nacelle 16 be constant (substantially constant).

Therefore, in the wind turbine generator 10 according to this embodiment, the yaw brake device 32 is controlled by the control device 36 so that the turning speed θ′ of the nacelle 16 falls within a predetermined range.

In the case in which the turning speed θ′ of the nacelle 16 is faster than the predetermined range, the control device 36 causes the yaw brake device 32 to a generate greater braking force to reduce the turning speed θ′ of the nacelle 16, thereby causing the turning speed θ′ to fall within the predetermined range. Accordingly, because the turning speed θ′ of the nacelle 16 varies within the predetermined range even if the force acting in the yaw direction transmitted to the nacelle 16 increases, the nacelle 16 can be prevented from abruptly changing its orientation.

On the other hand, in the case in which the turning speed θ′ of the nacelle 16 is lower than the predetermined range, the control device 36 causes the yaw brake device 32 to reduce the braking force to increase the turning speed θ′ of the nacelle 16, thereby causing the turning speed θ′ to fall within the predetermined range.

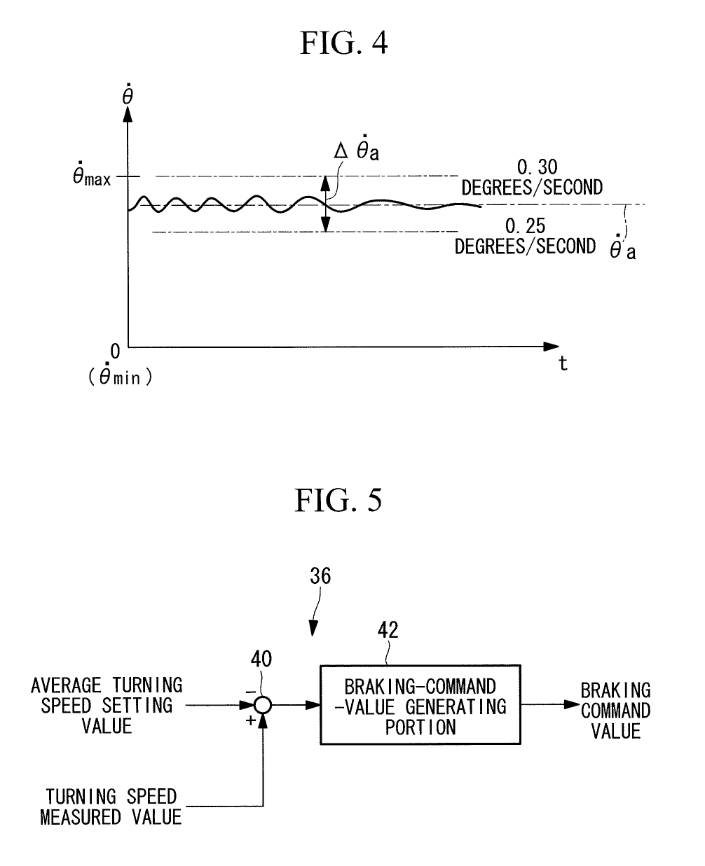

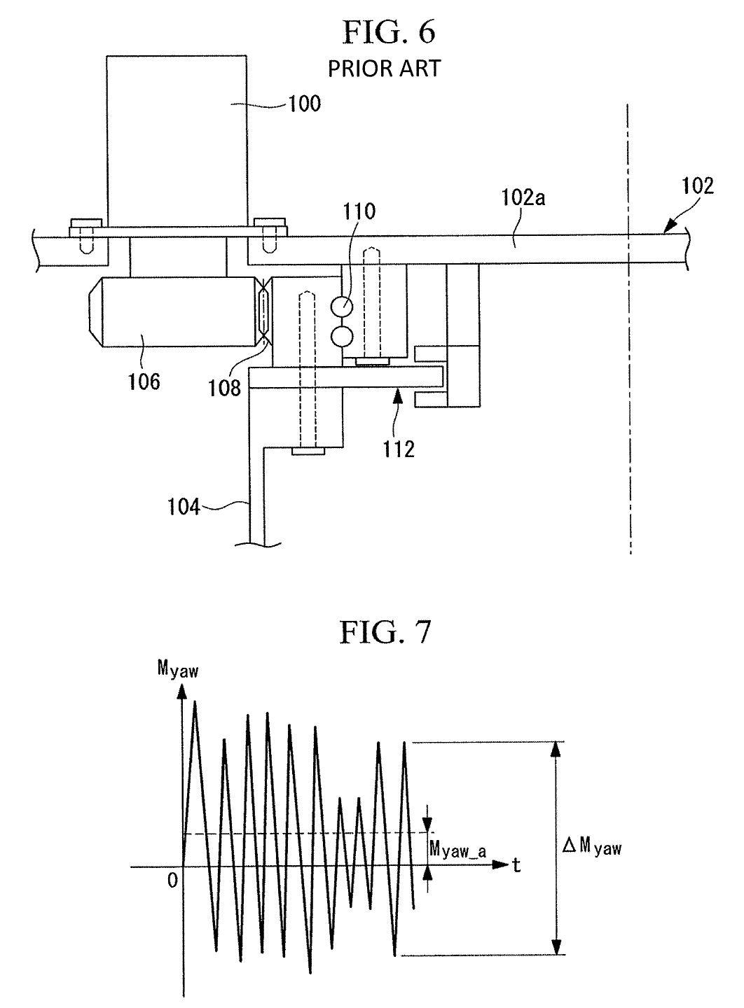

Note that, with regard to the predetermined range for the turning speed θ′ of the nacelle 16 in this embodiment, it is assumed that an average turning speed θ′a of the nacelle 16 falls within an allowable range Δθ′a, as shown in FIG. 4. It is preferable that the allowable range Δθ′a for the average turning speed θ′a be in a range from 0.25 degrees/second to 0.30 degrees/second. So long as it is within this range, abrupt turning of the nacelle 16 in the yaw direction can be prevented while maintaining the tracking performance with respect to the wind direction, without causing mechanical strain.

In addition, the predetermined range for the turning speed θ′ of the nacelle 16 may be set between a minimum value θ′min and a maximum value θ′max that are set in advance for the turning speed θ.

FIG. 5 is a functional block diagram, showing functions of the control device 36 that are related to control of the yaw brake device 32.

As shown in FIG. 5, in the control device 36, an average turning speed setting value that is set in advance and a turning speed measured value measured by the turning speed sensor 38 are input to a subtractor 40, and the difference between the average turning speed setting value and the turning speed measured value are calculated. Then, the difference output from the subtractor 40 is input to a braking-command-value generating section 42.

The braking-command-value generating section 42 generates the braking command values for controlling the yaw brake device 32 in accordance with the input difference and outputs them to the yaw-brake control device 34.

The braking-command-value generating section 42 generates the braking command values, for example, as described below, at predetermined time intervals such that the orientation of the nacelle 16 in the yaw direction can follow the wind fluctuations.

First, the braking-command-value generating section 42 determines whether or not the input difference falls within the allowable range Δθ′a and, if it is within the allowable range Δθ′a, does not change the braking command values.

In the case in which the input difference is outside of the allowable range Δθ′a, the braking-command-value generating section 42 generates the braking command values so that the yaw brake device 32 generates a braking force in accordance with the difference, and outputs them to the yaw-brake control device 34.

Specifically, table information in which the pressure that the brake pads 32b apply to the brake disk 32a and the number of brake pads 32b to be pressed into contact with the brake disk 32a are indicated in accordance with the difference between the average turning speed setting value and the turning speed measured value is prepared in advance and stored in a storing unit (not shown). Then, the braking-command-value generating section 42 reads out the pressure that the brake pads 32b apply to the brake disk 32a and the number of brake pads 32b to be pressed into contact with the brake disk 32a in accordance with the input difference from the table information stored in the storing unit, generates the braking command values, and outputs them to the yaw-brake control device 34.

The yaw-brake control device 34 controls the hydraulic pressure of working fluid so that the pressure indicated by the braking command value is generated at the number of brake pads 32a indicated by the braking command value.

By doing so, with the yaw brake device 32, the braking torque that acts on the nacelle 16 is increased when the difference is greater than the allowable range Δθ′a and is decreased when the difference is smaller than the allowable range Δθ′a. Therefore, because the braking force is controlled in accordance with the turning speed θ′ of the nacelle 16 instead of performing simple on/off control of the yaw brake device 32, as has conventionally been done, the turning speed θ′ of the nacelle 16 is controlled with high precision so as to fall within the allowable range Δθ′a.

As has been described above, the wind turbine generator 10 according to this embodiment is a wind turbine generator 10 that causes the nacelle 16 to turn in the yaw direction by using the force that acts on the turbine blades 20, in which the yaw brake device 32 that brakes the turning of the nacelle 16 in the yaw direction and the control device 36 that controls the yaw brake device 32 so that the turning speed θ′ of the nacelle 16 falls within the predetermined range are provided. Therefore, the wind turbine generator 10 according to this embodiment can make the turning speed θ′ of the nacelle 16 constant.

Although the present invention has been described above by using the above-described embodiment, the technical scope of the present invention is not limited to the scope disclosed in the above-described embodiment. Various alterations and improvements can be added to the above-described embodiment within a range that does not depart form the spirit of the invention, and the technical scope of the present invention also encompasses configurations to which the alterations and the improvements are added.

For example, although a configuration in which the braking command values indicate the pressure that the brake pads 32b apply to the brake disk 32a and the number of the brake pads 32b to be pressed into contact with the brake disk 32a has been described in this embodiment, the present invention is not limited thereto; a configuration in which the braking command value indicates only the pressure that the brake pads 32b apply to the brake disk 32a or a configuration in which the braking command value indicates only the number of brake pads 32b to be pressed into contact with the brake disk 32a may be employed.

In the configuration in which the braking command value indicates only the pressure that the brake pads 32b apply to the brake disk 32a, the yaw-brake control device 34 controls the braking force by simultaneously causing all of the plurality of the brake pads 32b to be pressed into contact with the brake disk 32a and by similarly changing the hydraulic pressure of the working fluid for all of the brake pads 32b. On the other hand, in the configuration in which the braking command value indicates only the number of brake pads 32b to be pressed into contact with the brake disk 32a, the yaw-brake control device 34 controls the braking force by making the hydraulic pressure of the working fluid the same for all of the brake pads 32b and by changing the number of brake pads 32b to be pressed into contact with the brake disk 32a.

In addition, although a configuration in which the braking-command-value generating section 42 generates the braking command values by using the table information stored in the storing unit has been described in the above-described embodiment, the present invention is not limited thereto; and a form in which the braking-command-value generating section 42 generates the braking command values by using a predetermined calculation formula may be employed.

### REFERENCE SIGNS LIST

10 wind turbine generator
20 turbine blade
32 yaw brake device
32a brake disk
32b brake pad
36 control device
38 turning speed sensor

1. A wind turbine generator that turns a nacelle in a yaw direction by using force that acts on wind turbine blades, the wind turbine generator comprising:
a braking unit for braking the turning of the nacelle in the yaw direction;
a measuring unit for measuring turning speed of the nacelle in the yaw direction; and
a controlling unit for controlling the braking unit so that the measured turning speed of the nacelle falls within a predetermined range,
wherein the controlling unit generates a control command value for the braking unit on a basis of a difference between the measured turning speed and turning speed set in advance in the predetermined range so that the measured turning speed of the nacelle in the yaw direction falls within the predetermined range.

2. A wind turbine generator according to claim 1, wherein the braking unit includes a plate-like brake disk and a plurality of brake pads that are pressed into contact with the brake disk, and in which at least one of a pressure that the brake pads apply to the brake disk and the number of brake pads to be pressed into contact with the brake disk is controlled so that the turning speed falls within the predetermined range.

3. (canceled)

4. A wind turbine generator according to claim 1, wherein the predetermined range for the turning speed is from 0.25 degrees/second to 0.30 degrees/second.

5. A yaw control method for a wind turbine generator that turns a nacelle in a yaw direction by using force that acts on turbine blades and that is provided with a braking unit that brakes the turning of the nacelle in the yaw direction, comprising:
measuring turning speed of the nacelle in the yaw direction;
controlling the braking unit on a basis of a difference between the measured turning speed and turning speed set in advance in a predetermined range so that the measured turning speed of the nacelle in the yaw direction falls within the predetermined range.
